(19) United States
(12) Patent Application Publication
(10) Pub. No.: US 2003/0199402 A1
(43) Pub. Date: Oct. 23, 2003

(54) Composition for reducing malodors and method for using the same

(76) Inventors: Carl Triplett, Scottsdale, AZ (US); Mengtao Pete He, Scottsdale, AZ (US); Paul Pappalardo, Scottsdale, AZ (US)

Correspondence Address: Damon L. Boyd, Snell & Wilmer L.L.P., One ArizonaCenter, 400 East Van Buren, Phoenix, AZ, 85004-2202, US

(21) Appl. No.: 10/378,845

(22) Filed: Mar. 4, 2003

Related U.S. Application Data
(60) Provisional application No. 60/374,928, filed on Apr. 22, 2002.

(51) Int. Cl. C11D 9/44

(52) U.S. Cl. 510/101

(57) ABSTRACT

A composition for reducing malodors in the air and on inanimate surfaces comprises a combination of at least one malodor neutralizing agent, at least one malodor binding agent, at least one malodor masking agent, and at least one performance agent. In accordance with one embodiment of the invention, the composition includes a surfactant component, a water dispersible polymer component, a metallic salt, a fragrance component, and a liquid carrier.

### CROSS-REFERENCE TO RELATED APPLICATION

This application claims priority from U.S. Provisional Patent Application Serial No. 60/374,928, entitled “Composition for Reducing Malodors and Method for Using the Same,” filed Apr. 22, 2002.

### FIELD OF INVENTION

The present invention relates to compositions for reducing malodors in the air and on inanimate surfaces, and more particularly to compositions comprising a combination of at least one malodor neutralizing agent, at least one malodor binding agent, at least one malodor masking agent, and at least one performance agent.

### BACKGROUND OF THE INVENTION

Various compositions for combating common household malodors are known in the art. Such compositions have been engineered for use as air freshening compositions, as fabric refresher compositions, as surface deodorizing compositions, and the like. Prior art compositions exhibit a multitude of malodor-combating mechanisms, fragrances, formulations, and applications. Nonetheless, however, prior art malodor reducing compositions typically exhibit a numbers of significant disadvantages.

One disadvantage of prior art malodor reducing compositions is the general inability for a single composition to combat a variety of malodors. Stated another way, most prior art malodor reducing compositions are formulated to be effective against specific types of malodors (e.g., bathroom odors, pet odors, etc.), but may not be satisfactorily effective at reducing other types of malodors (e.g., cigarette smoke, cooking odors, etc.), as different types of malodor molecules may require different mechanisms for reducing their perceptibility. For example, certain types of malodors may be easily and effectively masked with perfumes or other fragrances, whereas other types of malodors may require physical or chemical neutralization to decrease their perceptibility.

Another disadvantage of prior art malodor reducing compositions is their inability to effectively penetrate fabric articles and fibrous surfaces, such as carpeting, to combat malodors deep within the fibers. Although such compositions may effectively reduce the olfactory impression of malodors on the surface of fabric articles and fibrous surfaces, they are not satisfactorily effective at combating malodors within the fibers of such articles and surfaces without significantly wetting or saturating such articles in the compositions.

Another general disadvantage of prior art compositions, especially aqueous-based compositions, is the perceptible wetness of such compositions when dispensed into the air. Many compositions are dispensed in the form of relatively large fluid droplets that settle quickly onto surfaces, leaving the surfaces damp or wet, and are too heavy to be carried throughout a relatively large volume of air by common, light air currents before settling. Thus, relatively large amounts of such compositions must be dispensed into the air in order to effectively treat malodors throughout a large volume of air.

What is needed in the art is a composition for reducing malodors in the air and on inanimate surfaces that effectively addresses these and other disadvantages of prior art malodor reducing compositions.

### SUMMARY OF THE INVENTION

This summary of the invention is intended to introduce the reader to various exemplary aspects of the invention. Particular aspects of the invention are pointed out in other sections hereinbelow, and the invention is set forth in the appended claims which alone demarcate its scope.

In accordance with an exemplary embodiment of the invention, a composition for reducing malodors is provided that generally comprises at least one malodor neutralizing agent, at least one malodor binding agent, at least one malodor masking agent, and at least one performance agent.

In accordance with another exemplary embodiment of the present invention, a composition for reducing malodors is provided. The composition generally includes a surfactant component, a water dispersible polymer component, a metallic salt, a fragrance component, and a liquid carrier. The surfactant component is present in an amount of at least about 3% by weight of the composition. The water dispersible polymer component is present in an amount of from about 0.01% to about 5% by weight of the composition. The metallic salt, preferably zinc ricinoleate, is present in an amount of from about 0.01% to about 5% by weight of the composition. The fragrance component is present in an amount of from about 0.1% to about 2.0% by weight of the composition. The liquid carrier generally comprises water.

In accordance with one aspect of an exemplary embodiment of the present invention, a composition for reducing malodors in the air and on inanimate surfaces preferably uses multiple malodor combating mechanisms, such as, for example, chemical neutralization, physical neutralization, absorption, masking, binding, and/or other mechanisms for reducing the perceptibility of malodors.

In accordance with another aspect of an exemplary embodiment of the present invention, the droplet size of the malodor reducing composition when dispensed into the air is sufficiently small so that the composition exhibits minimal wetness impression when used as an air freshener. Preferably, the droplet size of the malodor reducing composition when dispensed into the air is sufficiently small to allow wide dispersion of the composition by naturally present air currents. Such a feature allows effective malodor reduction in a relatively large area while utilizing a relatively small amount of malodor reducing composition.

In accordance with a preferred aspect of the present invention, a malodor reducing composition exhibits good wetting properties, such that the composition effectively penetrates fibers of fabric articles and other fibrous surfaces, such as carpeting, to combat malodors within the fibers.

In accordance with another aspect of an exemplary embodiment of the present invention, the malodor reducing composition is not damaging to carpets, fabrics, or other household surfaces under conditions of normal use.

### DETAILED DESCRIPTION

The following descriptions are of exemplary embodiments of the invention only, and are not intended to limit the scope, applicability or configuration of the invention in any way. Rather, the following description is intended to provide convenient illustrations for implementing various embodiments of the invention. As will become apparent, various changes may be made in the function and arrangement of the elements described in these embodiments without departing from the sprit and scope of the invention.

In accordance with an exemplary embodiment of the present invention, a composition for reducing malodors is provided that generally comprises at least one malodor neutralizing agent, at least one malodor binding agent, at least one malodor masking agent, and at least one performance agent.

Malodor Neutralizing Agent

In accordance with a preferred aspect of an exemplary embodiment of the invention, a composition for reducing malodors comprises at least one malodor neutralizing agent. The malodor neutralizing agent can comprise any agent that is capable of reducing the level of undesirable malodors available for human perception or that is capable of otherwise decreasing the level to which malodors are perceived. A variety of mechanisms exist by which a malodor neutralizing agent may reduce perceptible malodors, such as, for example, chemically reacting with malodor molecules, complexing with malodor molecules, absorbing malodor molecules, encapsulating malodor molecules, and/or influencing the ability of human sensory receptors to perceive malodors (e.g., anosmia).

Malodor neutralizing agents suitable for use in accordance with an exemplary embodiment of the invention may combat malodors by chemically reacting or complexing with malodor molecules, by blocking human sensory reception sites that detect the presence of malodor, or by otherwise treating, blending, reacting, or counteracting malodors without increasing the perceived overall odor level in a particular environment. Stated another way, fragrances comprising malodor neutralizing agents as herein defined result in substantial elimination of the perceived odor level of a particular malodor or malodor combination such that the user is not compelled to dispense increasing amounts of the malodor-reducing composition into the air in an attempt to mask the malodor to the extent that its perceived odor level is very low. Moreover, because the malodor is substantially eliminated while reducing the total perceivable odor level, the use of such agents does not result in the total perceived odor level increasing, and instead, the perceived odor level after dispensing the malodor-reducing composition is preferably below the total perceived odor level before dispensing. And while various malodor neutralizing agents may be used to selectively control and/or eliminate malodors, preferred malodor neutralizing agents will not affect the desirable odors of the masking agents.

In accordance with one aspect of an exemplary embodiment of the invention, metallic salts can be used effectively as malodor neutralizing agents. In accordance with an aspect of another exemplary embodiment of the invention, a zinc salt, particularly zinc ricinoleate, may be used as a malodor neutralizing agent. Zinc ricinoleate may stably complex with malodor molecules. The mode by which zinc ricinoleate complexes with malodors is similar to and can be compared to the iron binding and transport of oxygen in hemoglobin—the zinc acts as a catalyst to bind the malodor molecules, complexing it with the fatty acid side chains of the zinc ricinoleate molecule. In this way, the zinc ricinoleate neutralizes the malodors—that is, it reduces the level of undesirable malodors available for human perception.

In accordance with an aspect of another exemplary embodiment of the invention, cyclodextrin can be used effectively as a malodor neutralizing agent. Various types of cyclodextrins may be used in accordance with this aspect, including, for example, alpha-cyclodextrin, beta-cyclodextrin, gamma-cyclodextrin and/or their derivatives and/or mixtures thereof.

In accordance an aspect of yet another exemplary embodiment of the invention, the fragrance component may comprise a malodor neutralizing agent insofar as it reduces the level of malodors available for human perception or otherwise decreases the level to which malodors are perceived. For example, fragrance components such as those disclosed in U.S. Pat. No. 5,795,566, which comprise at least two aldehydes, may perform a malodor neutralizing function as well as an odor masking function insofar as such fragrance components may react with malodor molecules to render them unperceivable by the human senses. For instance, some malodor molecules contain reactive R—OH functional groups or R—SH functional groups, and as such may form adducts with certain reactive aldehydes, such as hemiacetals and/or hemithioacetals, which are less volatile and/or less odoriferous than the original malodors.

Malodor Binding Agent

In accordance with another aspect of an exemplary embodiment of the invention, a composition for reducing malodors comprises at least one malodor binding agent. As used herein, the malodor binding agent generally comprises any agent to which malodor molecules can physically adhere. In this way, the malodor binding agent effectively traps malodor molecules within it and/or on its surface, rendering these molecules less perceptible by the human senses. Preferably, the malodor binding agent comprises an agent capable of forming a film on which malodor molecules and/or other undesirable odoriferous compounds may adhere.

In accordance with an exemplary embodiment of the present invention, a water dispersible polymer is utilized as a malodor binding agent, which physically binds malodor molecules via the formation of a malodor-adherent polymer film. For example, when a composition containing a water dispersible polymer and formulated in accordance with various other aspects of the present invention is dispensed onto an inanimate surface, such as fabric article, the viscosity of the composition increases quickly as the water evaporates from the composition and the polymer film forms. As the polymer film dries, it stably fixes within it malodor molecules that it has contacted, due to the viscous, adherent nature of the polymer itself. Similarly, the polymer film may capture, for example, molecules of the malodor neutralizing agents that may have complexed with malodor molecules, and thus prevents those molecules from being further dispersed.

Malodor binding agents useful in accordance with this aspect of the invention preferably will not be damaging to fabrics, carpets, and other surfaces in the amounts present in the malodor-reducing composition. They should, however, exhibit sufficient tack or stickiness when dried to form a film such that they provide a matrix in which malodor molecules may be entrapped, but not so much that to the human touch a resulting film imparts an obvious sticky feel. Preferably, the malodor binding agent will not exhibit an obvious or offensive odor, although malodor binding agents having such characteristics may still be utilized effectively through judiciously selecting a malodor masking agent that mitigates such characteristics.

Malodor Masking Agent

In accordance with another aspect of an exemplary embodiment of the invention, a composition for reducing malodors comprises at least one malodor masking agent. In general, malodor masking agents conceal undesirable malodors by adding desirable odors to a degree such that the desirable odors are perceived to a greater extent than the undesirable malodors. In this way, although malodor molecules are left chemically and physically unchanged, human sensory perception detects the desirable odor either instead of or to a greater degree than the undesirable malodor, resulting in a positive performance impression.

As herein defined, a malodor masking agent may comprise any odoriferous agent that blends with, adds to, or overpowers the malodor in such a way as to “mask” the malodor or substitute its odor for that of the malodor. Preferably, the malodor masking agent has a pleasant, or at least non-offensive, aroma. One or more malodor masking agents may be combined to achieve effective malodor counteraction by masking.

In accordance with a preferred aspect of an exemplary embodiment of the invention, the malodor masking agent comprises a perfume or other fragrant compound, such as an alcohol, essential oil, phenol, or ester.

Performance Agent

In accordance with a preferred aspect of an exemplary embodiment of the invention, a composition for reducing malodors comprises at least one performance agent. As used herein, the term “performance agent” is used to describe any agent suitable for enhancing the solubility of the various other components of the malodor-reducing composition, enhancing the clarity, stability, and/or homogeneity of the malodor-reducing composition, enhancing the wetting properties of the malodor-reducing composition, and/or reducing the surface tension of the water in an aqueous composition such that droplet size is minimized upon dispersing the composition. Any compound exhibiting one or more of the above functional characteristics may be utilized as a performance agent in accordance with an exemplary embodiment of the present invention.

Performance agents useful in accordance with this aspect of the invention preferably will not be damaging to fabrics, carpets, and/or other surfaces in the amounts present in the malodor-reducing composition. Most preferred are performance agents that, when used in effective amounts in the malodor-reducing composition, will not soil, stain, bleach, discolor, or otherwise detrimentally affect the appearance of fabrics, carpets, and/or other surfaces which the malodor-reducing agent may contact.

In accordance with one aspect of an exemplary embodiment of the invention, the performance agent comprises one or more surfactants. The present inventors have observed that surfactants may serve as solubilizing aids, to facilitate solubilization of the various components of the composition, such as, for example, those malodor-counteracting agents that are not readily soluble in the composition. In accordance with an aspect of another exemplary embodiment of the invention, a non-foaming or low-foaming surfactant is employed as a performance agent.

In accordance with another aspect of an exemplary embodiment of the invention in which the performance agent comprises one or more surfactants, when the malodor-reducing composition is utilized on fabric articles or other fibrous surfaces, such as carpeting, surfactants present in the composition enhance the wetting characteristics of the composition. In this way, the surfactants facilitate penetration or “wicking” of the malodor-counteracting components of the composition into the fibers of the fabric, carpet, or other surface, thereby enabling absorption, neutralization, masking and/or binding of malodor molecules present below the surface of the article. This aspect is particularly advantageous over prior art malodor-reducing compositions that do not comprise a performance agent, such as, for example, a surfactant. Indeed, prior art malodor-reducing compositions tend to counteract only malodors present at or near the surface of fabric or fibrous articles, as they do not employ performance agents, such as surfactants, in amounts effective to enable thorough wetting of the surface of the article and penetration of the active malodor-counteracting components into the article. Moreover, surfactants aid in maintaining adequate emulsification and/or dispersion of the various malodor-counteracting components of the composition, resulting in a more efficient malodor-reducing composition and more effective malodor reduction.

In accordance with yet another aspect of an exemplary embodiment of the invention in which the performance agent comprises one or more surfactants, when the malodor-reducing composition is utilized as an air freshener, the surfactants present in the composition facilitate reduction of the surface tension of the water present in the composition, and thus facilitate reduction of the median droplet size of the liquid composition ultimately dispensed into the air and/or onto a fabric and/or fibrous surface to be deodorized. Reduction of the median droplet size has the advantage of, inter alia, reducing the “wetness” perception of the composition when dispensed into the air, as smaller liquid droplets result in increased overall surface area of the dispensed composition, and thus an increased evaporation rate. Moreover, reduction of median droplet size allows for increased dispersion of the composition in the air, as smaller droplets are more easily carried throughout the air by naturally present air currents before settling to the ground. In this way, a relatively large volume of airspace may be effectively treated with a relatively small amount of malodor-reducing composition.

In accordance with another exemplary embodiment of the present invention, a composition for reducing malodors is provided that generally includes a surfactant component, a water dispersible polymer component, a metallic salt, a fragrance component, and a liquid carrier.

Surfactant

In one aspect of an exemplary embodiment of the invention, a surfactant component is present in an amount of at least about 3% by weight of the composition. Suitable surfactants for use in accordance with the present invention include nonionic surfactants, cationic surfactants, anionic surfactants, amphoteric surfactants, zwitterionic surfactants, and mixtures thereof. Preferably, anionic surfactants, nonionic surfactants, and mixtures thereof are utilized in accordance with this aspect of the invention. The chosen surfactant may have emulsification and/or detersive properties and/or good wetting properties. Exemplary nonionic and anionic surfactants include, but are not limited to, straight chain primary alkoxylated alcohols, including straight chain primary ethoxylated alcohols; alkoxylate polymers, such as alkoxylate copolymers and alkoxylate homopolymers, including ethoxylate homopolymers; long-chain fatty acids; sulfosuccinates; alkyl sulfates, phosphates, and sulfonates. Preferably, the surfactant component comprises one or more of block copolymers of ethylene and/or propylene oxide, linear and/or branched alkoxylated alcohols, and linear and/or branched alkoxylated alkylphenols.

In an exemplary embodiment of the present invention, the surfactant is present in the composition in an amount greater than about 3% by weight of the composition, preferably from about 3% to about 10% by weight of the composition, and most preferably from about 3% to about 5% by weight of the composition. In accordance with a preferred aspect of an exemplary embodiment of the invention, the surfactant comprises Tomadol™ 25-12 alcohol ethoxylate, available from Tomah Products, Inc.

Polymer

In another aspect of an exemplary embodiment of the invention, a polymer component, preferably a water dispersible polymer component, is present in an amount of from about 0.01% to about 5% by weight of the composition. Virtually any water-soluble or water dispersible film-forming polymer may be used in connection with the present invention. Examples of suitable classes of polymers useful in accordance with the present invention include, but are not limited to, the following:

(a) Acrylate Polymers

Acrylic emulsion polymers are generally suitable for use in connection with various embodiments of the present invention. These are generally copolymers of one or more acidic monomers, such as acrylic acid, methacrylic acid or maleic anhydride, with at least one other ethylenically unsaturated monomer selected from a group consisting of ethylene and other simple olefins, styrene, alpha-methylstyrene, methyl, ethyl and C₃ to C₈ alkyl acrylates and methacrylates, isobornyl methacrylate, acrylamide, hydroxyethyl acrylate and methacrylate, hydroxypropyl acrylate and methacrylate, N-vinyl pyrrolidone, butadiene, isoprene, vinyl halides such as vinyl chloride and vinylidine chloride, alkyl maleates, alkyl fumarates, fumaric acid, maleic acid, itoconic acid, and the like. It is also frequently desirable to include minor amounts of other functional monomers, such as acetoacetoxy methacrylate or other acetoacetate monomers and divinyl or polyvinyl monomers, such as glycol polyacrylates, allyl methacrylate, divinyl benzene and the like. The preferred polymers have an acid number from about 75 to about 500 and a number average molecular weight of about 500 to about 20,000. Examples of such acrylic emulsion polymers include those available from National Starch and Chemical, such as Amaze, Flexan and Balance CR, Balance 47 and Balance 055. Other preferred polymers are Carboset GA233, EX561 and 2123, all by Noveon, Inc. Other suitable polymers are copolymers of acrylic and/or methacrylic acid with acrylate and methacrylate esters.

Other suitable polymers may include cationic acrylic water-soluble polymers that are copolymers of cationic quaternized acrylates, methacrylates, acrylamides, and methacrylamides, for example trimethylammoniumpropylmethacrylate, and acrylamide or acrylonitrile.

(b) Polystyrenesulfonates

Other suitable polymers are polystyrenesulfonates, such as Flexan 130 and Versa TL501 from National Starch and Chemical. Polystyrenesulfonates are also useful as copolymers, for examples, Versa TL-4, also from National Starch and Chemical.

(c) Polycarboxylates

Polycarboxylates can also be used in connection with various embodiments of the present invention, which contain amounts of nonionizable monomers, such as ethylene and other simple olefins, styrene, alpha-methylstyrene, methyl, ethyl and C₃ to C₈ alkyl acrylates and methacrylates, isobornyl methacrylate, acrylamide, hydroxyethyl acrylate and methacrylate, hydroxypropyl acrylate and methacrylate, N-vinylpyrrolidone, butadiene, isoprene, vinyl halides such as vinyl chloride and vinylidine chloride, alkyl maleates, alkyl fumarates. Other suitable polymers include other polycarboxylates, such as homopolymers and copolymers of monomeric units selected from the group consisting of unsaturated carboxylic acids such as acrylic acid, methacrylic acid, polycarboxylic acids, sulfonic acids, phosphonic acids and mixtures thereof. Copolymerization of the above monomeric units among them or with other co-monomers such as maleic anhydride, ethylene or propylene are also suitable.

(d) Polyethyleneamines

Other suitable polymers are polyethyleneamines and copolymers with other polyalkyleneamines. These amino-functional polymers can also be modified by ethoxylation and propoxylation. These amino-functional polymers can also be quaternized with methyl groups or oxidized to amine oxides.

(e) Polyvinylpyrrolidones

Other suitable polymers include vinylpyrrolidone homopolymers and copolymers. Suitable vinylpyrrolidone homopolymers have an average molecular weight of from about 1,000 to about 100,000,000, preferably from about 2,000 to about 10,000,000, and more preferably from about 5,000 to about 1,000,000. Such vinylpyrrolidone homopolymers are commercially available from ISP Corporation, Wayne, N.J. under the product names PVP K-15 (average molecular weight of 8,000), PVP K-30 (average molecular weight of 38,000), PVP K-60 (average molecular weight of 216,000), PVP K-90 (average molecular weight of 630,000), and PVP K-120 (average molecular weight of 2,900,000). Suitable copolymers of vinylpyrrolidone include copolymers of N-vinylpyrrolidone with one or more alkylenically unsaturated monomers. Suitable alkylenically unsaturated monomers include unsaturated dicarboxylic acids such as maleic acid, chloromaleic acid, fumaric acid, itaconic acid, citraconic acid, phenylmaleic acid, aconitic acid, acrylic acid, methacrylic acid, N-vinylimidazole, vinylcaprolactam, butane, hexadecane, and vinyl acetate. Any of the esters and amides of the unsaturated acids may be employed, for example, methyl acrylate, ethylacrylate, acrylamide, methacrylamide, dimethylaminoethylmethacrylate, dimethylamino-propylmethacrylamide, trimethyl-ammoniumethylmethacrylate, and trimethylammoniumpropylmethacrylamide. Other suitable alkylenically unsaturated monomers include aromatic monomers such as styrene, sulphonated styrene, alpha-methylstyrene, vinyltoluene, t-butylstyrene and others.

(f) Methylvinyl Ether

Other suitable polymers for use in accordance with various embodiments of the present invention include methylvinylether homopolymers and copolymers. Preferred copolymers are those with maleic anhydride. These copolymers can be hydrolyzed to the diacid or derivitized as the monoalkyl ester. For example, the n-butyl ester is available as Gantrez ES-425 from ISP Corporation.

(g) Polyvinyl Alcohols

Other suitable polymers for use in accordance with various embodiments of the present invention include polyvinyl alcohols. Preferably, polyvinyl alcohols which are at least 80.0%, and preferably 88.0-99.9% hydrolyzed are used. For example, the polyvinyl alcohol, Elvanol 71-30 is available from E. I. DuPont de Nemours and Company, Wilmington, Del.

(h) Fluoropolymers

Fluoropolymers useful in accordance with various embodiments of the invention include those which have a molecular weight of at least about 5,000 Daltons, more preferably at least about 10,000 Daltons. Such fluoropolymers can be at least partially substituted with water solubilizing groups, such as, without limitation, carboxyl, amido, sulfonato, ethoxyl, propoxyl and the like. It is preferred that the fluoropolymers be at least water-dispersible, and more preferably, are at least partially water-soluble.

Mixtures of any of the foregoing polymers may be possible or desirable.

Commercially available water dispersible polymers useful in accordance with a preferred embodiment of the present invention include, for example, Eastman AQ 38S, Eastman AQ 48 Ultra, and Eastman AQ 55S, which are linear, amorphous polyesters (INCI name diglycol/CHDM/isophthalates/SIP copolymer) manufactured by Eastman Chemical Company in Kingsport, Tenn., USA. In an exemplary embodiment of the present invention, a linear, amorphous polyester, such as, for example, Eastman AQ 55S, is present in the composition in an amount of from about 0.01% to about 5% by weight of the composition, preferably from about 0.05% to about 3% by weight of the composition, and most preferably from about 0.1% to about 1% by weight of the composition.

Polymers useful in accordance with this aspect of the invention preferably will not be damaging to fabrics, carpets, and other surfaces in the amounts present in the malodor reducing composition, but preferably exhibit some level of tack or stickiness when dried. Preferably, the polymer will not exhibit an obvious or offensive odor, although polymers having such characteristics may still be utilized effectively through judiciously selecting a fragrance component that mitigates such characteristics.

Metallic Salt

In accordance with another aspect of an exemplary embodiment of the invention, a metallic salt, preferably a water-soluble zinc salt, is present in an amount of from about 0.05% to about 5% by weight of the composition. Preferably, the metallic salt is at least one of zinc ricinoleate, zinc chloride, zinc gluconate, zinc lactate, zinc maleate, zinc salicylate, zinc sulfate, and mixtures thereof. Most preferably, the metallic salt is zinc ricinoleate.

Zinc ricinoleate controls malodors selectively through a chemical binding of low molecular weight organic compounds containing the osmogene functional groups. On the other hand, zinc ricinoleate generally has no effect on carbonylic groups, such as aldehydes and ketones, which comprise typical perfume and fragrance components.

Preferably, in the present inventive composition, zinc ricinoleate molecules complex with one or more malodor molecules, depending on the size and shape of the malodor molecule(s). Once the complex is formed, it is a stable complex, that is, the malodor molecule will not be released from the zinc ricinoleate, even when the substrate dries.

In an exemplary embodiment of the present invention, zinc ricinoleate is present in the composition in an amount of from about 0.01% to about 5% by weight of the composition, preferably from about 0.05% to about 3% by weight of the composition, and most preferably from about 0.1% to about 2% by weight of the composition. Zinc ricinoleate is commercially available as, for example, TEGO® Sorb Conc 50 (zinc ricinoleate with solubilizers, 50% solution), TEGO® Sorb PY 88 TQ (zinc ricinoleate with solubilizers, 10% solution), and TEGO® Sorb 51 (zinc ricinoleate, 100% solid) from Degussa Goldschmidt Chemical Corporation in Hopewell, Va., USA.

Fragrance

In accordance with another aspect of an exemplary embodiment of the invention, a fragrance component is present in an amount of from about 0.1% to about 2.0% by weight of the composition. In a preferred aspect of an exemplary embodiment of the invention, the fragrance component chosen serves as both a malodor neutralizing agent and a malodor-masking agent.

Fragrance components useful in connection with the present invention are available from any number of sources, for example, from International Flavors & Fragrances of New York, N.Y. and Robertet S. A., of Grasse, France. A variety of fragrance components are available that employ any number of malodor-neutralizing mechanisms in addition to malodor masking agents, and any such fragrance components are suitable for use in connection with the various embodiments of the present invention.

In an exemplary embodiment of the present invention, the fragrance component is selected from fragrances containing unsubstituted cyclohexyl alcohols and esters as disclosed in, for example, U.S. Pat. Nos. 4,719,105 and 4,622,221, both of which are incorporated by reference herein. Such fragrance components are available from International Flavors & Fragrances, and may exhibit any number of desirable odors. For example, desirable odors of various alkyl substituted cyclohexyl alkanols include, but are not limited to: cis/trans-4-tert. butyl cyclohexyl methanol (green fresh steamy floral jasmine), cis/trans-1-(4-tert. butyl cyclohexyl)-1-ethanol (sharp floral musky), cis/trans-1-(4-ethyl cyclohexyl)-1-ethanol (floral woody fresh rose), cis/trans-1-(methyl cyclohexyl)-1-ethanol (sour citrus lime camphor), cis/trans-2-(4-methyl cyclohexenyl)-2-propanol (lilac), and 1-cis(4-isopropenylcyclohexyl)-methanol (flowery). As a further example, desirable odors of various substituted cyclohexyl alkyl esters include, but are not limited to: 4-isopropylcyclohexylmethyl acetate (fragrant, flowery), 1-(3,3 dimethylcyclohexyl)-1-ethanol acetate (sweet woody, floral), 1-(3-methylcyclohexyl)-1-ethyl acetate (fresh, clean, minty, woody), 2-(4′-methylcyclohexyl)-2-propanol acetate (mild herbaceous sweet spicy bergamot, lavender), and 2-cyclohexylethanol acetate (powerful, sweet, fruity).

In another exemplary embodiment of the present invention, the fragrance component is selected from fragrances containing at least two aldehydes, as disclosed in, for example, U.S. Pat. No. 5,795,566, which is incorporated by reference herein. Such fragrance components are available from Robertet, S. A., and are generally characterized as having at least one aldehyde selected from acyclic aliphatic aldehydes, non-terpenic aliphatic aldehydes, non-terpenic alicyclic aldehydes, terpenic aldehydes, aliphatic aldehydes substituted by an aromatic group and bifunctional aldehydes, and at least one aldehyde selected from aldehydes possessing a non-aromatic unsaturation alpha carried by the carbon which is alpha to the aldehyde, aldehydes possessing an unsaturation alpha to the aldehyde function conjugated with an aromatic ring, and aldehydes in which the aldehyde group is on an aromatic ring. These fragrance components additionally comprise a fragrant agent imparting a desirable odor to the fragrance, such as, for example, alcohols, essential oils, phenols, and esters.

In an exemplary embodiment of the present invention, the fragrance component is present in the composition in an amount of from about 0.1% to about 2.0% by weight of the composition, preferably from about 0.3% to about 1.5% by weight of the composition, and most preferably from about 0.5% to about 1.2% by weight of the composition.

Liquid Carrier

The preferred liquid carrier for use in accordance with an exemplary embodiment of the present invention is water, which can be distilled, deionized, or unrefined tap water. In a preferred aspect of an exemplary embodiment, the liquid carrier comprises at least about 85% by weight of water; however, so long as sufficient water is present in the composition to effectively solubilize and/or disperse the other components of the composition, less water may be used. In another aspect of a preferred embodiment of the invention, wherein zinc ricinoleate is employed as the metallic salt, it is preferable that water comprise at least about 10% by weight of the composition so as to activate the zinc ricinoleate molecules as described hereinabove.

The liquid carrier may also comprise a fraction of a low molecular weight monohydric alcohol, such as, for example, ethanol, methanol, or isopropanol; a polyol, such as ethylene glycol, diethylene glycol, propylene glycol, or dipropylene glycol; a polyol derivative; or a glycol ether. Such a fraction of a monohydric alcohol, polyol, polyol derivative, or glycol ether may serve to enhance the solubility of various components and to aid in the maintenance of a clear, stable, microemulsion of the various components.

Optional Additives

In other exemplary embodiments of the present invention, the composition may include one or more other conventional additives such as preservatives, antifoaming agents, bacteriocides, fungicides, antistatic agents, miticides, insect repellants, colorants, and mixtures thereof. One or more of such additives may be present in any amount suitable to achieve a particular objective.

Coloring Agents

Optionally, compositions formulated in accordance with the various aspects of the present invention may also include coloring agents or dyes to increase the aesthetic appeal and consumer performance impression of the compositions. When present, such coloring agents and/or dyes are preferably used at very low levels to avoid staining or marking surfaces on which the compositions may be used, such as, for example, fabric articles or upholstery. A wide variety of coloring agents and dyes suitable for use in accordance with the present invention are well known to those skilled in the art. In accordance with a preferred aspect of an exemplary embodiment of the invention, water-soluble dyes, such as, for example, food dyes, may be used in small amounts. For example, about 0.000025% by weight of FD&C Red No. 4 may be used for a light pink tint, a mixture of about 0.000025% by weight of FD&C Red No. 4 and about 0.000050% by weight of FD&C Yellow No. 6 may be used to achieve a composition having a light orange tint, or a mixture of about 0.000010% by weight of FD&C Blue No. 1 and about 0.000030% by weights of FD&C Yellow No. 6 may be used to achieve a composition having a light green tint. When used in connection with malodor treating compositions packaged in transparent bottles, these exemplary tints may be used to distinguish variously fragranced compositions on a retail store shelf and to increase consumer purchase appeal. For example, compositions formulated in accordance with the present invention and tinted in accordance with the above described exemplary aspect can be packaged in natural high density polyethylene (HDPE), clear polyethylene terephthalate (PET) or polyvinylchloride (PVC) plastic bottles, allowing the tinted compositions to be visible through the packaging.

Preservative

Optionally, a solubilized preservative can be added to the composition of the present invention. As is known in the art, contamination of aqueous compositions by certain microorganisms with subsequent microbial growth can result in an unsightly and/or malodorous composition. Because microbial growth in aqueous compositions containing biodegradable components, such as biodegradable surfactants, is undesirable, it is preferable to include in such aqueous compositions an amount of a solubilized water-soluble, antimicrobial preservative that is effective for inhibiting and/or controlling microbial growth. Use of such a preservative in this way increases the storage stability of the preferably clear, aqueous malodor-reducing composition.

It is preferable to utilize a preservative agent that is effective to inhibit and/or control both bacteria and fungi. When present, the water-soluble microbial preservative is included at an effective amount. The term “effective amount” as herein defined means a level sufficient to prevent spoilage or to prevent growth of microorganisms for a specific period of time, but not a level enough to affect the malodor-reducing performance of the composition. Preferred levels of preservative, when present, are from about 0.01% to about 0.5% by weight of the composition, more preferably from about 0.02% to about 0.2% by weight of the composition, and most preferably from about 0.05% to about 0.1% by weight of the composition.

Suitable preservatives may include any organic preservative that will not adversely affect or damage fabric articles or fibrous surfaces in the amounts present in the malodor-reducing compositions of the present invention. Preferred water-soluble preservatives include, for example, halogenated compounds, hydantoin compounds, organic sulfur compounds, low molecular weight aldehydes, cyclic organic nitrogen compounds, quaternary compounds, dehydroacetic acid, phenyl and phenoxy compounds, and mixtures thereof. In accordance with an aspect of an exemplary embodiment of the present invention, an effective amount of Dantogard® preservative, available from Lonza Group of Switzerland, is utilized in a malodor-reducing composition.

pH Adjusting Agents

For optimum odor control and to maintain clarity of the composition, it is preferable that the pH of the composition be adjusted to less than about 8, more preferably less than about 6, and most preferably from about 3 to about 5. Various pH-adjusting agents are known in the art and can be used to bring the pH of the composition of the instant invention to within the preferred range. In one aspect of an exemplary embodiment of the invention, the pH-adjusting agent is selected from the group consisting of citric acid, lactic acid, phosphoric acid, and mixtures thereof. In one aspect of a preferred embodiment of the invention, citric acid is present in an amount effective to adjust the pH of the composition to within the preferred pH range, generally in an amount from about 0.1% to about 1.0% by weight of the composition.

In a preferred embodiment of the invention, these additives, alone or combined, are not present in an amount that is greater than about 4% by weight of the composition. More preferably, these additives, alone or combined, are present in an amount that is less than about 2% by weight of the composition, and even more preferably, less than about 1% by weight of the composition. However, any effective amount of optional additives, alone or combined, may be utilized in accordance with the present invention insofar as such additives do not detrimentally affect the malodor-counteracting properties of the malodor-reducing composition.

The following is a non-limiting example of one embodiment of the invention. The components are mixed to form a clear, homogeneous microemulsion.

| Components | Weight % |
|---|---|
| Eastman AQ 55S linear polyester | 0.50 |
| Surfonic L 25-12 surfactant | 3.34 |
| TEGO ® Sorb 50 Conc zinc ricinoleate | 0.10 |
| Fragrance A | 1.00 |
| Ethanol, denatured, 200-proof | 7.00 |
| Dantogard preservative | 0.24 |
| Citric acid crystals | 0.05 |
| Water | Balance |

In accordance with another exemplary embodiment of the invention, a composition for reducing malodors is provided that generally comprises at least one malodor neutralizing agent, at least one malodor binding agent, at least one malodor masking agent, and at least one performance agent.

Dispensing Device

In accordance with one aspect of an exemplary embodiment of the invention, a malodor-reducing composition formulated in accordance with any of the above-described embodiments may be used, for example, as an air freshener composition, as a fabric refresher composition, and/or as a deodorizing composition for other fibrous surfaces.

In accordance with an exemplary embodiment of the present invention, an article of manufacture comprises a spray dispenser and a malodor-reducing composition. The malodor-reducing composition in accordance with one of the various embodiments described in greater detail hereinabove is placed into a spray dispenser suitable for distributing the composition into the air or onto an inanimate surface, such as, for example, a fabric article or other fibrous surface, such as carpeting. The spray dispenser may comprise any manually operated or automated means of producing a mist of liquid droplets, such as, for example, trigger-type, pump-type, non-aerosol self-pressurized, and aerosol-type spray means.

Preferably, when used as an air freshener composition, a malodor-reducing composition formulated in accordance with any of the above-described embodiments is dispensed such that the droplet size, dispersion angle, dispersion pattern, dispersion volume and/or dispersion velocity enable effective freshening of an airspace with a minimum number of activations of the spray dispenser. Similarly, when used as a fabric freshener or other fibrous surface refresher composition, a malodor-reducing composition formulated in accordance with any of the above-described embodiments is dispensed such that the droplet size, dispersion angle, dispersion pattern, dispersion volume and/or dispersion velocity enable effective coverage of the surface of the article to be deodorized with a minimum number of activations of the spray dispenser.

In accordance with one aspect of an exemplary embodiment of the invention, it is preferred that the droplets have an average particle size of from about 20 to about 80 μm. More preferably, the droplets will have an average particle size of from about 30 to about 70 μm, and most preferably, the droplets will have an average particle size of from about 40 to about 60 μm.

In accordance with an exemplary embodiment of the present invention, a green inserted Guala® trigger sprayer available from Guala Dispensing U.S.A. Corp., Hillsborough, N.J., is utilized because of the fine uniform spray characteristics, spray volume, and spray pattern size and shape. Any suitable bottle or container can be used with the trigger sprayer. In a preferred embodiment of the present invention, compositions formulated in accordance with the present invention and tinted in accordance with the above described exemplary aspects can be packaged in natural high density polyethylene (HDPE), clear polyethylene terephthalate (PET) or polyvinylchloride (PVC) plastic bottles, allowing the tinted compositions to be visible through the packaging.

Various principles of the invention have been described in illustrative embodiments. However, many combinations and modifications of the above-described structures, arrangements, proportions, elements, materials and components, used in the practice of the invention, in addition to those not specifically described, may be varied and particularly adapted to specific environments and operating requirements without departing from those principles. Stated another way, the above description presents exemplary modes contemplated in carrying out the invention and the techniques described are susceptible to modifications and alternate constructions from the embodiments shown above. Other variations and modifications of the present invention will be apparent to those of ordinary skill in the art, and it is the intent of the appended claims that such variations and modifications be covered.

Consequently, it is not the intention to limit the invention to the particular embodiments disclosed. On the contrary, the invention is intended to cover all modifications and alternate constructions falling within the scope of the invention, as expressed in the following claims when read in light of the description. No element described in this specification is necessary for the practice of the invention unless expressly described herein as “essential” or “required.”

1. A composition for reducing malodors comprising:
at least one malodor neutralizing agent;
at least one malodor binding agent;
at least one malodor masking agent; and
at least one performance agent.

2. The composition of claim 1, wherein said at least one malodor neutralizing agent comprises at least one of a metallic salt, cyclodextrin, a reactive aldehyde, and combinations thereof.

3. The composition of claim 1, wherein said at least one malodor neutralizing agent comprises zinc ricinoleate.

4. The composition of claim 1, wherein said at least one malodor neutralizing agent comprises at least one of alpha-cyclodextrin, beta-cyclodextrin, gamma-cyclodextrin, and derivatives and mixtures thereof.

5. The composition of claim 1, wherein said at least one malodor neutralizing agent comprises at least two reactive aldehydes.

6. The composition of claim 1, wherein said at least one malodor binding agent comprises a water dispersible polymer.

7. The composition of claim 1, wherein said at least one malodor masking agent comprises at least one of a perfume, an alcohol, an essential oil, a phenol, an ester, or other fragrant compound.

8. The composition of claim 1, wherein said at least one performance agent comprises at least one surfactant.

9. The composition of claim 2, wherein said at least one surfactant comprises at least one non-foaming or low-foaming surfactant.

10. An article of manufacture comprising:
a composition for reducing malodors, said composition comprising
at least one malodor neutralizing agent;
at least one malodor binding agent;
at least one malodor masking agent; and
at least one performance agent; and
a dispensing device.

11. The article of manufacture of claim 10, wherein said dispensing device is adapted to distribute said composition in the form of droplets.

12. The article of manufacture of claim 10, wherein said dispensing device comprises a spray dispenser.

13. The article of manufacture of claim 12, wherein said spray dispenser is adapted to distribute said composition in the form of droplets having an average particle size of from about 20 to about 80 μm.

14. The article of manufacture of claim 12, wherein said spray dispenser is adapted to distribute said composition in the form of droplets having an average particle size of from about 30 to about 70 μm.

15. The article of manufacture of claim 12, wherein said spray dispenser is adapted to distribute said composition in the form of droplets having an average particle size of from about 40 to about 60 μm.

16. A composition for reducing malodors comprising:
a surfactant component;
a water dispersible polymer component;
a metallic salt;
a fragrance component; and
a liquid carrier.

17. The composition of claim 16 wherein said surfactant component is present in an amount of at least about 3% by weight of the composition.

18. The composition of claim 16 wherein said surfactant component comprises at least one of a straight chain primary alkoxylated alcohol, an alkoxylate polymer, a long-chain fatty acid, a sulfosuccinate, an alkyl sulfate, a phosphate, or a sulfonate.

19. The composition of claim 16 wherein said surfactant component comprises at least one of a block copolymer of ethylene oxide, a block copolymer of propylene oxide, a linear alkoxylated alcohol, a branched alkoxylated alcohol, a linear alkoxylated alkylphenol, or a branched alkoxylated alkylphenol.

20. The composition of claim 16 wherein said water dispersible polymer component is present in an amount of from about 0.01% to about 5% by weight of the composition.

21. The composition of claim 16 wherein said water dispersible polymer component comprises at least one of an acrylate polymer, a polystyrenesulfonate, a polycarboxylate, a polyethyleneamine, a polyvinylpyrrolidone, a methyl vinyl ether, a polyvinyl alcohol, or a fluoropolymer.

22. The composition of claim 16 wherein said water dispersible polymer component comprises a linear, amorphous polyester.

23. The composition of claim 16 wherein said metallic salt is present in an amount of from about 0.01% to about 5% by weight of the composition.

24. The composition of claim 16 wherein said metallic salt comprises at least one of zinc ricinoleate, zinc chloride, zinc gluconate, zinc lactate, zinc maleate, zinc salicylate, zinc sulfate, or other water soluble zinc salt.

25. The composition of claim 16 wherein said metallic salt comprises zinc ricinoleate.

26. The composition of claim 16 wherein said fragrance component is present in an amount of from about 0.1% to about 2% by weight of the composition.

27. The composition of claim 16 wherein said fragrance comprises an unsubstituted cyclohexyl alcohol.

28. The composition of claim 16 wherein said fragrance comprises an ester.

29. The composition of claim 16 wherein said fragrance comprises at least two aldehydes.

30. The composition of claim 29 wherein said fragrance comprises at least one aldehyde selected from acyclic aliphatic aldehydes, non-terpenic aliphatic aldehydes, non-terpenic alicyclic aldehydes, terpenic aldehydes, aliphatic aldehydes substituted by an aromatic group and bifunctional aldehydes; and
at least one aldehyde selected from aldehydes possessing a non-aromatic unsaturation alpha carried by the carbon which is alpha to the aldehyde, aldehydes possessing an unsaturation alpha to the aldehyde function conjugated with an aromatic ring, and aldehydes in which the aldehyde group is on an aromatic ring.

31. The composition of claim 16 wherein said liquid carrier comprises water.

32. A method for treating undesirable malodors in an environment comprising adding to said environment an amount of a composition according to claim 1 effective to reduce the level of undesirable malodors perceptible by human senses in said environment.

33. A method for treating undesirable malodors on a fibrous surface comprising applying to said surface an amount of a composition according to claim 1 effective to reduce the level of undesirable malodors perceptible by human senses on said surface.

34. A method for treating undesirable malodors on a fabric article comprising applying to said fabric article an amount of a composition according to claim 1 effective to reduce the level of undesirable malodors perceptible by human senses on said fabric article.

35. A method for treating undesirable malodors in an environment comprising adding to said environment an amount of a composition according to claim 16 effective to reduce the level of undesirable malodors perceptible by human senses in said environment.

36. A method for treating undesirable malodors on a fibrous surface comprising applying to said surface an amount of a composition according to claim 16 effective to reduce the level of undesirable malodors perceptible by human senses on said surface.

37. A method for treating undesirable malodors on a fabric article comprising applying to said fabric article an amount of a composition according to claim 16 effective to reduce the level of undesirable malodors perceptible by human senses on said fabric article.
